(19) United States
(12) Patent Application Publication
(10) Pub. No.: US 2020/0049885 A1
(43) Pub. Date: Feb. 13, 2020

(54) JACKET REMOVAL TOOL FOR OPTICAL CABLE AND METHOD FOR REMOVING JACKET OF OPTICAL CABLE

(71) Applicant: Fujikura Ltd., Tokyo (JP)

(72) Inventors: Terutake Kobayashi, Chiba (JP); Norihiro Momotsu, Chiba (JP)

(73) Assignee: Fujikura Ltd., Tokyo (JP)

(21) Appl. No.: 16/496,187

(22) PCT Filed: Jan. 12, 2018
(86) PCT No.: PCT/JP2018/000690

§ 371 Date: Sep. 20, 2019

(30) Foreign Application Priority Data
Mar. 22, 2017 (JP) 2017-055753

(51) Int. Cl. G02B 6/245

(52) U.S. Cl. CPC G02B 6/245; B26B 5/00

(57) ABSTRACT

A jacket removal tool for an optical cable in which a rip cord is buried in a jacket is provided. The jacket removal tool includes: a blade that shaves the jacket; and a blade counterpart. An opening through which a part of the jacket shaved by the blade passes is disposed between the blade and the blade counterpart. The blade counterpart includes: a counter bottom surface along the optical cable; a counter side surface connected to the counter bottom surface; and an edge that connects the counter bottom surface and the counter side surface and that is disposed along a perpendicular line extending from a cutting edge of the blade with respect to the counter bottom surface. The edge is parallel to a blade line of the cutting edge.

### TECHNICAL FIELD

The present invention relates to a jacket removal tool for an optical cable and a method for removing a jacket of an optical cable.

### BACKGROUND

Patent Literature 1 describes a jacket removal tool for an optical cable in which a peeling blade having a predetermined angle with respect to an optical cable digs in and removes a jacket. Patent Literature 2 describes a jacket removal tool for an optical cable that removes a jacket by sliding toward a longitudinal direction of an optical cable while sandwiching the optical cable with a blade provided in a groove of a jacket removal tool body for the optical cable, and takes out a rip cord.

### PATENT LITERATURE

Patent Literature 1: JP 2002-64916A
Patent Literature 2: JP 2016-10207A

In the jacket removal tool for an optical cable described in Patent Literature 1, the peeling blade is pressed against a jacket of an optical cable and slides on the jacket toward the longitudinal direction, and thus the jacket is shaved in such a way as to peel a skin of a fruit. Thus, a deeper cutting depth in the jacket increases resistance received by a cutting edge from the jacket, which makes it difficult to shave the jacket while accurately determining a depth at which a rip cord is buried. Further, shifting of the peeling blade during shaving generates a step at a cut end, and shaving at a constant depth in the longitudinal direction is difficult.

On the other hand, in the jacket removal tool for an optical cable described in Patent Literature 2, when a depth at which a rip cord is buried is deep, great force is needed to slide the jacket removal tool toward the longitudinal direction, and the jacket removal tool may not slide in some cases. Furthermore, in this jacket removal tool for an optical cable, a shaving thickness of a jacket is constant according to a depth at which a rip cord is buried, and thus a plurality of jacket removal tools are needed for each optical cable having a different depth at which a rip cord is buried.

### SUMMARY

One or more embodiments of the present invention provide a jacket removal tool for an optical cable capable of easily removing a jacket of an optical cable.

One or more embodiments of the invention provide a jacket removal tool for an optical cable in which a rip cord is buried in a jacket, the jacket removal tool comprising: a blade that shaves the jacket; and a blade counterpart that forms, together with the blade, an opening through which a part of the jacket shaved by the blade passes, wherein the blade counterpart includes a counter bottom surface along the optical cable, and a counter side surface connected to the counter bottom surface, an edge part (edge) that serves as a connection part between the counter bottom surface and the counter side surface is located on a perpendicular line extending from a cutting edge of the blade with respect to the counter bottom surface, and the edge part is parallel to a blade line of the cutting edge.

Other features of the invention are made clear by the following description and the drawings.

According to one or more embodiments of the present invention, it is possible to easily remove a jacket of an optical cable.

### BRIEF DESCRIPTION OF THE DRAWINGS

FIG. 1 is a cross-sectional view of an optical fiber cable 50.

FIG. 2 is a perspective view of an overall of a jacket removal tool 1 according to one or more embodiments.

FIG. 3A is a bottom view of the jacket removal tool 1 according to one or more embodiments. FIG. 3B is a cross-sectional view of the jacket removal tool 1 according to one or more embodiments taken along an A-A line in FIG. 3A.

FIG. 4 is a cross-sectional perspective view of a blade part 5.

FIG. 5 is an explanatory diagram illustrating a positional relationship between a blade 6 and a blade counterpart 8.

FIGS. 6A to 6C are explanatory diagrams illustrating a method for removing a jacket by the jacket removal tool 1 according to one or more embodiments.

FIGS. 7A to 7C are explanatory diagrams illustrating a method for removing a jacket by a jacket removal tool 1 according to one or more embodiments.

FIGS. 8A to 8E are explanatory diagrams illustrating a method for removing a jacket according to a modified example.

### DETAILED DESCRIPTION

At least the following matters are made clear from the following description and the drawings.

A jacket removal tool for an optical cable in which a rip cord is buried in a jacket will become clear, the jacket removal tool comprising: a blade that shaves the jacket; and a blade counterpart that forms, together with the blade, an opening through which a part of the jacket shaved by the blade passes, wherein the blade counterpart includes a counter bottom surface along the optical cable, and a counter side surface connected to the counter bottom surface, an edge part that serves as a connection part between the counter bottom surface and the counter side surface is located on a perpendicular line extending from a cutting edge of the blade with respect to the counter bottom surface, and the edge part is parallel to a blade line of the cutting edge. With such a jacket removal tool for an optical cable, the jacket of the optical cable can be easily removed.

A distance between the edge part and the cutting edge may be smaller than a buried depth of the rip cord. In this way, by shaving the jacket for a plurality of times until the rip cord is exposed, shaving to a depth deeper than the buried depth of the rip cord can be suppressed, and damage to a wrapping tape and an optical fiber inside the wrapping tape can be suppressed.

A jacket removal tool according to one or more embodiments of the present invention may include a body part (body) that holds the blade counter part, wherein a groove part (groove) that guides the optical cable is formed in the body part. In this way, slipping of the optical cable from the jacket removal tool when the jacket is shaved can be suppressed.

A bottom surface of the groove part may be a surface curved so as to protrude toward the optical cable side. In this way, the cutting edge can be pressed against the jacket even when the optical cable is bent during shaving of the jacket.

A jacket removal tool according to one or more embodiments of the present invention may further include a shaving stopper that prevents shaving of the jacket to a depth deeper than the rip cord. In this way, shaving to a depth deeper than the buried depth of the rip cord can be suppressed, and damage to a wrapping tape and an optical fiber inside the wrapping tape can be suppressed.

A method for removing a jacket of an optical cable will become clear, comprising: preparing a jacket removal tool for an optical cable in which a rip cord is buried in a jacket, the jacket removal tool including a blade that shaves the jacket, and a blade counterpart that forms, together with the blade, an opening through which a part of the jacket shaved by the blade passes, the blade counterpart including a counter bottom surface along the optical cable, and a counter side surface connected to the counter bottom surface, an edge part that serves as a connection part between the counter bottom surface and the counter side surface being located on a perpendicular line extending from a cutting edge of the blade with respect to the counter bottom surface, and the edge part being parallel to a blade line of the cutting edge; and pressing the blade against the jacket, moving the jacket removal tool along a longitudinal direction of the optical cable to remove the jacket. With this method for removing a jacket of an optical cable, it is possible to easily remove a jacket of an optical cable.

A method may further include performing the movement for a plurality of times until the rip cord is exposed. In this way, by shaving the jacket for a plurality of times until the rip cord is exposed, shaving to a depth deeper than the buried depth of the rip cord can be suppressed, and damage to a wrapping tape and an optical fiber inside the wrapping tape can be suppressed.

Before a jacket removal tool according to one or more embodiments is described, first, a configuration of an optical fiber cable being a jacket removal target is described.

Configuration of Optical Fiber Cable being Jacket Removal Target:

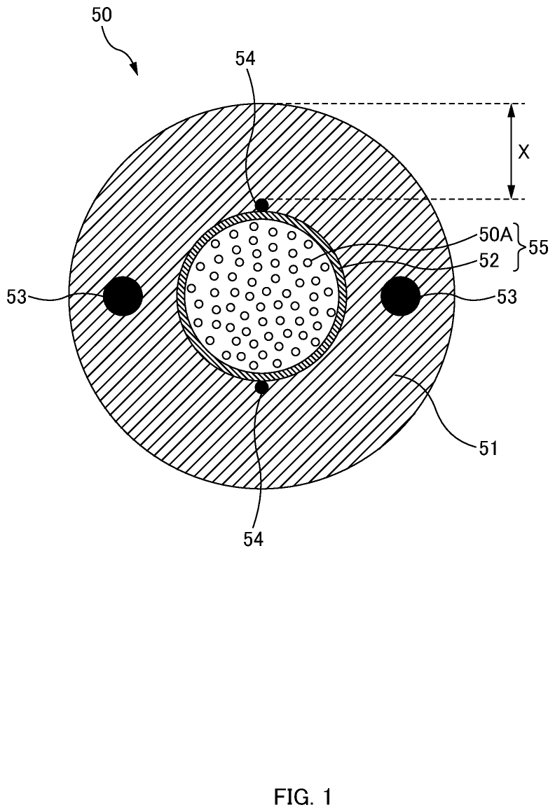

FIG. 1 is a cross-sectional view of an optical fiber cable 50. The optical fiber cable 50 includes an optical fiber unit 55, a jacket 51, tensile strength members 53, and rip cords 54. Note that the optical fiber cable is also simply referred to as an “optical cable”.

The optical fiber unit 55 is a unit (aggregation) formed by wrapping a plurality of optical fibers 50A with a wrapping tape 52. The optical fiber unit 55 is also referred to as a “core of an optical fiber cable”, an “optical fiber core”, a “core unit”, simply a “unit”, or the like in some cases. Note that a bundle of the plurality of optical fibers 50A wrapped with the wrapping tape 52 is not limited to a bundle formed by bundling many single-core optical fibers 50A together, and may include a plurality of bundle units (not illustrated) formed by bundling a plurality of optical fiber ribbons with a bundling member, and be constituted by wrapping the plurality of bundle units with the wrapping tape 52.

The wrapping tape 52 is a member that wraps the plurality of optical fibers 50A. Wrapping the optical fibers 50A with the wrapping tape 52 can prevent, when coating is applied with molten resin to form the jacket 51, the optical fibers 50A from being buried in (digging into) the jacket 51. A polyimide tape, a polyester tape, a polypropylene tape, a polyethylene tape, or the like is used for the wrapping tape 52. Alternatively, nonwoven fabric may be used as the wrapping tape 52. In this case, tape-like nonwoven fabric made of polyimide, polyester, polypropylene, polyethylene, or the like is used. The wrapping tape 52 may be nonwoven fabric with a film, such as a polyester film, being stuck thereto.

The jacket 51 is a member for coating the optical fiber unit 55, the tensile strength members 53, and the rip cords 54. The outside shape (cross section) of the jacket 51 is circular. As a material of the jacket 51, resin, such as polyvinyl chloride (PVC), polyethylene (PE), nylon (trademark), fluorinated ethylene, or polypropylene (PP), may be used, for example. In the case of using polyethylene (PE), high-density polyethylene, medium-density polyethylene, low-density polyethylene, straight-chain low-density polyethylene, or the like may be used. As a material of the jacket 30, a polyolefin compound containing, as fire retardant, a hydrated metal compound, such as magnesium hydroxide or aluminum hydroxide, may be used, for example. Note that a member different from the optical fiber unit 55, the tensile strength members 53, and the rip cords 54 may be buried in the jacket 51.

The tensile strength members 53 are members that hold against contraction of the jacket 51 and suppress distortion and bending applied to the optical fiber unit 55 (especially, the optical fibers 50A) due to the contraction of the jacket 51. The tensile strength members 53 are linear members and are buried in the jacket 51. As a material of the tensile strength members 53, a nonmetallic material or a metallic material may be used. As the nonmetallic material, glass FRP (GFRP), aramid fiber reinforced plastics reinforced by Kevler (trademark) (KFRP), or fiber reinforced plastics (FRP), such as polyethylene fiber reinforced plastics reinforced by polyethylene fiber, may be used, for example. As the metallic material, a metallic wire, such as a steel wire, may be used.

In the optical fiber cable 50 illustrated in FIG. 1, the two tensile strength members 53 are buried in the jacket 51. However, the number of tensile strength members 53 is not limited to two and may be three or more. In the region sandwiched between the two tensile strength members 53, a housing part of the optical fiber unit 55 is formed.

The rip cords 54 are string-like members used for ripping the jacket 51 of the optical fiber cable 50. An operator rips the jacket 51 by pulling any of the rip cords 54, removes the jacket 51, and takes out the optical fiber unit 55 (optical fibers 50A) in the optical fiber cable 50. As a material of the rip cords 54, for example, fibers such as polyester, polyimide, and aramid, an aggregation of fibers, fibers impregnated with resin, a strand of a plurality of aggregations of fibers, or the like may be used.

In the optical fiber cable 50 illustrated in FIG. 1, the two rip cords 54 are aligned vertically to be adjacent to a periphery of the optical fiber unit 55, and are buried together with the optical fiber unit 55 in the jacket 51. In the optical fiber cable 50 illustrated in FIG. 1, the rip cord(s) 54 is buried in a position at a depth X from a surface of the jacket 51. Hereinafter, X may be referred to as a “buried depth”.

As described above, the operator needs to pull the rip cord 54 in order to rip the jacket 51 of the optical fiber cable 50. In order to hold the rip cord 54 with a hand and pull the rip cord 54, the operator needs to shave the jacket 51 beforehand, and expose a part of the rip cord 54 buried in the jacket 51. Note that a place on the jacket 51 in which the rip cord 54 is buried may be formed in a protruding shape in order to easily determine which part of the jacket 51 is to be shaved such that the rip cord 54 can be exposed.

Basic Configuration of Jacket Removal Tool:

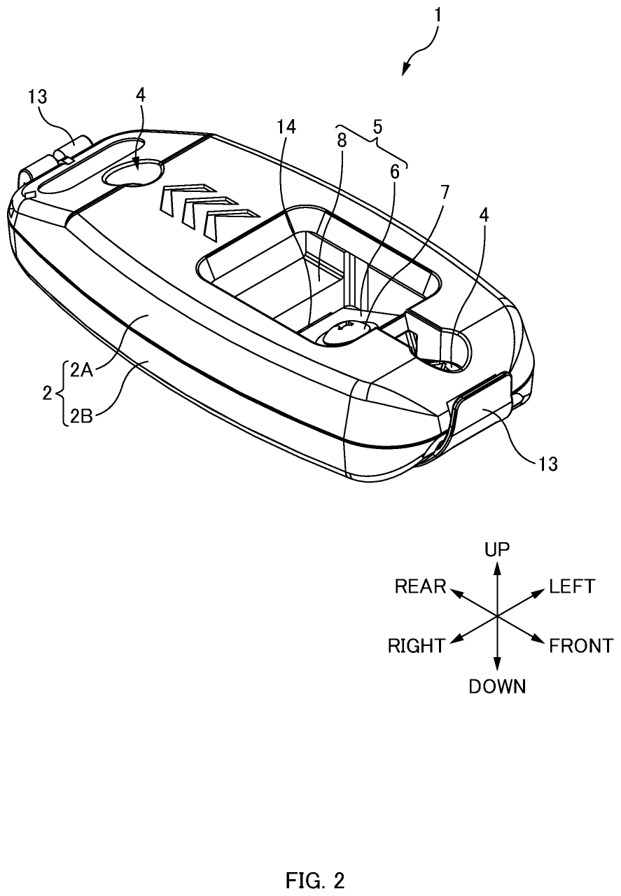

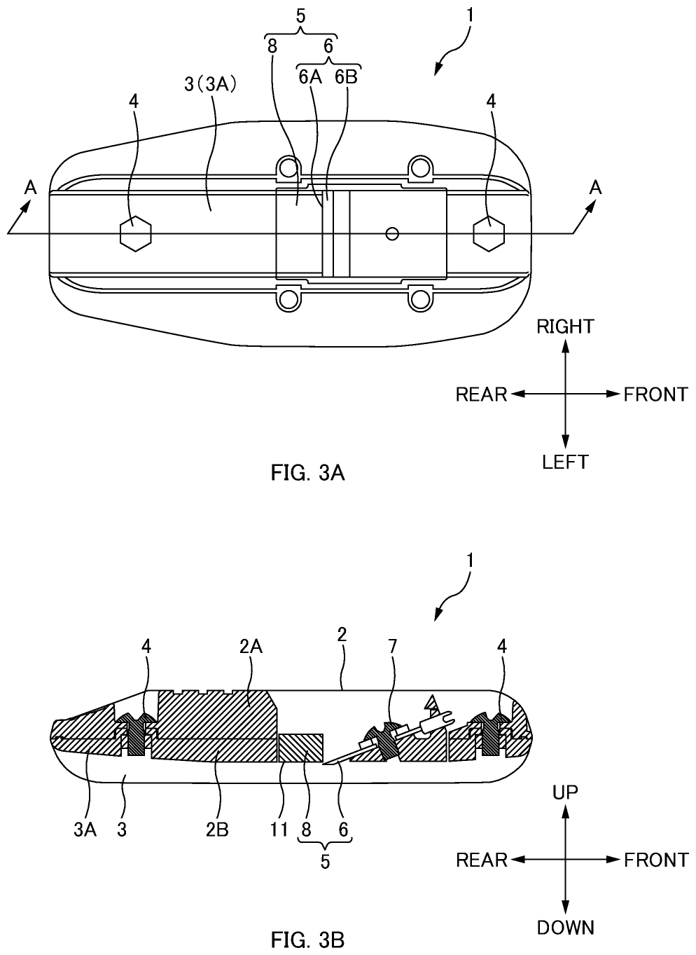

Next, a jacket removal tool according to one or more embodiments will be described. FIG. 2 is a perspective view of an overall of a jacket removal tool 1 according to one or more embodiments. FIG. 3A is a bottom view of the jacket removal tool 1 according to one or more embodiments. FIG. 3B is a cross-sectional view of the jacket removal tool 1 according to one or more embodiments taken along an A-A line in FIG. 3A. First, a basic configuration of the jacket removal tool 1 illustrated in FIGS. 1 and 2 is described, and a detailed configuration of a blade part 5 that is a characteristic part of the jacket removal tool 1 according to one or more embodiments is then described.

In the following description, directions will be defined as illustrated in the drawings. In other words, a direction (a longitude direction of the optical fiber cable 50) in which the jacket removal tool 1 is moved when the jacket 51 of the optical fiber cable 50 is shaved is referred to as a “front-rear direction”, a side that a cutting edge 6A of a blade 6 faces is referred to as “rear” (refer to FIG. 3B), and an opposite side is referred to as “front”. Moreover, a direction of a blade line of the cutting edge 6A is referred to as a “left-right direction”, a right side when the front side is seen from the rear side is referred to as “right”, and an opposite side is referred to as “left”. Moreover, a direction perpendicular to the front-rear direction and the left-right direction is referred to as an “up-down direction”, a side on which a body part 2 is located with respect to the cutting edge 6A is referred to as “up”, and an opposite side (a side on which the cutting edge 6A is located) is referred to as “down”.

The jacket removal tool 1 is a tool for removing a jacket of an optical fiber cable. A jacket of an optical fiber cable is shaved by using the jacket removal tool 1 to expose a part of a rip cord, and thus the rip cord can be pulled in order to rip the jacket. The jacket removal tool 1 includes the body part 2, the blade part 5, and a lid 13.

The body part 2 is a member that holds the blade part 5 (a blade counter part 8 to which the blade 6 is fixed) described later. The body part 2 is also a member as a handle when an operator shaves a jacket of an optical fiber cable by using the jacket removal tool 1. The body part 2 includes a recessed part in an upper surface, and a part of the blade part 5 is exposed in this recessed part (refer to FIG. 2). Moreover, the blade 6 of the blade part 5 is exposed from a lower surface (a lower body part 2A described later) (refer to FIG. 3A).

The body part 2 includes an upper body part 2A and the lower body part 2B. In the jacket removal tool 1 according to one or more embodiments, the upper body part 2A and the lower body part 2B sandwich and hold the blade part 5. Note that the upper body part 2A and the lower body part 2B are fixed with fixing screws 4 in two places. In this way, the blade part 5 is also held with respect to the body part 2. However, fixing of the upper body part 2A and the lower body part 2B and fixing of the blade part 5 with respect to the body part 2 are not limited to this, and fixing may be performed by a method without using the fixing screws 4.

In the lower body part 2B, a groove part 3 is formed for guiding an optical fiber cable when a jacket of the optical fiber cable is shaved. The groove part 3 is formed so as to extend in the front-rear direction of the lower body part 2B. The operator shaves a jacket by pressing the blade 6 exposed from the lower body part 2B against the jacket of an optical fiber cable, and moving the blade 6 toward the rear. At this time, an optical fiber cable is guided by the groove part 3. In this way, slipping of an optical fiber cable from the jacket removal tool when the jacket is shaved can be suppressed.

The blade part 5 is a member that shaves a jacket of an optical fiber cable. The blade part 5 is held by the body part 2 (the upper body part 2A and the lower body part 2B). A detailed configuration of the blade part 5 will be described later.

The lid 13 is a member that is fitted in the groove part 3 formed in the body part 2 (the lower body part 2B) and covers the blade 6 exposed from the lower body part 2B. Moreover, the lid 13 can be removed from the body part 2 (the lower body part 2B) during an operation of removing a jacket of an optical fiber cable. In this way, when the jacket removal tool 1 is not used, the blade 6 can be protected from damage, and the operator's finger can also be prevented from touching the blade 6. However, the lid 13 may not be provided.

Blade Part:

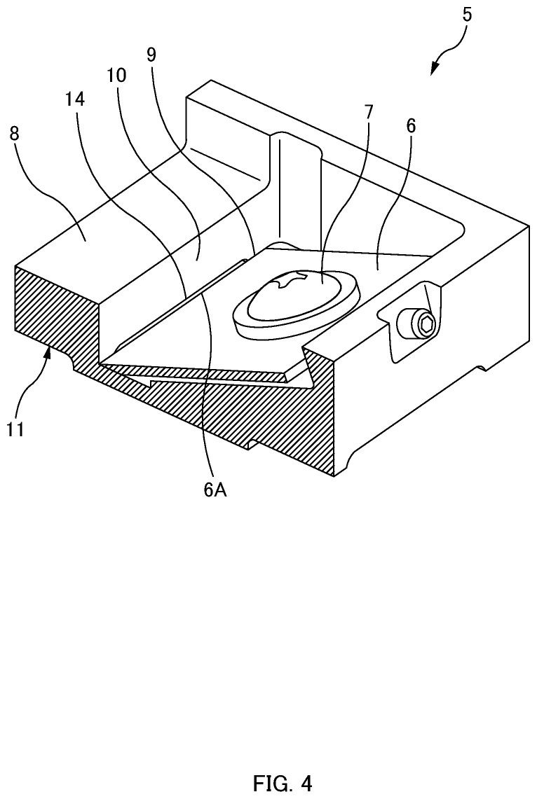

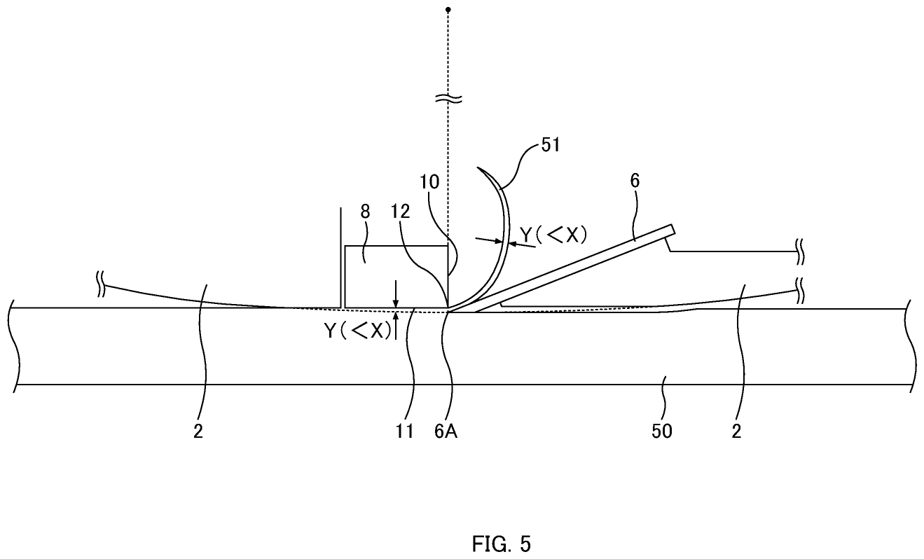

Next, a detailed configuration of the blade part 5 is described. FIG. 4 is a cross-sectional perspective view of the blade part 5. FIG. 5 is an explanatory diagram illustrating a positional relationship between the blade 6 and the blade counter part 8. The blade part 5 includes the blade 6 and the blade counter part 8. The blade 6 and the blade counter part 8 are fixed with a fixing screw 7, but may be integrally formed.

The blade 6 is a member that serves as a blade when a jacket of an optical fiber cable is shaved. The blade 6 is inclined with respect to the blade counter part 8 described later and fixed with the fixing screw 7 while the cutting edge 6A faces downward. Furthermore, the blade 6 is fixed with left and right ends of the cutting edge 6A abutting a blade rest 9 of the blade counter part 8.

The blade counter part 8 is a member that holds the blade 6. The blade counter part 8 holds the blade 6 so as to house the blade 6 in the recessed part provided in the blade counter part 8. A counter side surface 10 and a counter bottom surface 11 are formed at the rear of the blade fixing part 8.

The counter side surface 10 is a part that allows the blade 6 to abut. Places of the counter side surface 10 that allow both ends of the blade 6 to abut form the blade rest 9. Moreover, an opening 14 is formed in a place sandwiched by the blade rest 9. As described later, the opening 14 is a place through which a part of the jacket 51 shaved by the blade 6 passes.

The counter bottom surface 11 is a part followed by an optical fiber cable when a jacket of the optical fiber cable is shaved. In other words, when the operator presses the blade 6 of the jacket removal tool 1 against an optical fiber cable and moves the blade 6 toward the rear, the optical fiber cable is guided by the counter bottom surface 11 and digs into the cutting edge 6A of the blade 6, and a part of a jacket is shaved (refer to FIG. 5).

The counter bottom surface 11 is formed so as to be connected to the counter side surface 10, and its connection place is an edge part 12. The edge part 12 of the jacket removal tool 1 according to one or more embodiments is located on a perpendicular line extending from the cutting edge 6A of the blade 6 with respect to the counter bottom surface 11 (refer to FIG. 5). In other words, the edge part 12 is located right above the cutting edge 6A.

Herein, a shaving thickness by an operation (hereinafter may be referred to as a shaving operation) of pressing the blade 6 of the jacket removal tool 1 against an optical fiber cable and moving the blade 6 toward the rear is defined by a distance between the edge part 12 described above and the cutting edge 6A (Y in FIG. 5). The edge part 12 of the jacket removal tool 1 according to one or more embodiments is located on the perpendicular line extending from the cutting edge 6A of the blade 6 with respect to the counter bottom surface 11 (in other words, the edge part 12 is located right above the cutting edge 6A). Thus, until one shaving operation is completed after the cutting edge 6A digs into the jacket 51 of the optical fiber cable 50, a shaving thickness does not increase or decrease, and can be substantially constant (Y) in the shaving. In this way, when a plurality of times of the shaving operations are performed until the rip cord 54 is exposed, a shaving thickness of the jacket for once can be constant.

Moreover, the edge part 12 is parallel to the edge line of the cutting edge 6A (refer to FIG. 4). In this way, a shaving thickness in the left-right direction of the shaved jacket 51 can also be constant (Y).

Furthermore, a distance (Y) between the edge part 12 and the cutting edge 6A is smaller than the buried depth (X) of the rip cord 54 (Y<X). In this way, by shaving the jacket for a plurality of times until the rip cord 54 is exposed, shaving to a depth deeper than the buried depth of the rip cord 54 can be suppressed, and damage to a wrapping tape and an optical fiber inside the wrapping tape can be suppressed.

As illustrated in FIG. 5, a bottom surface of the body part 3 (the groove part 3) is a surface curved so as to protrude toward the optical fiber cable 50 side. The cutting edge 6A is formed so as to be located on a tip of the protrusion, and thus the cutting edge can be reliably pressed against the jacket 51 even when the optical fiber cable 50 is bent during shaving of the jacket 51. Note that a cross-sectional line of the curved surface forms a circular arc, and the center of the circular arc is located on a straight line from the cutting edge 6A to the edge part 12. However, the cross-sectional line of the curved surface may not be formed by a circular arc in such a manner as long as the bottom surface of the body part 3 (the groove part 3) protrudes toward the optical fiber cable 50 side.

Method for Removing Jacket by Jacket Removal Tool 1:

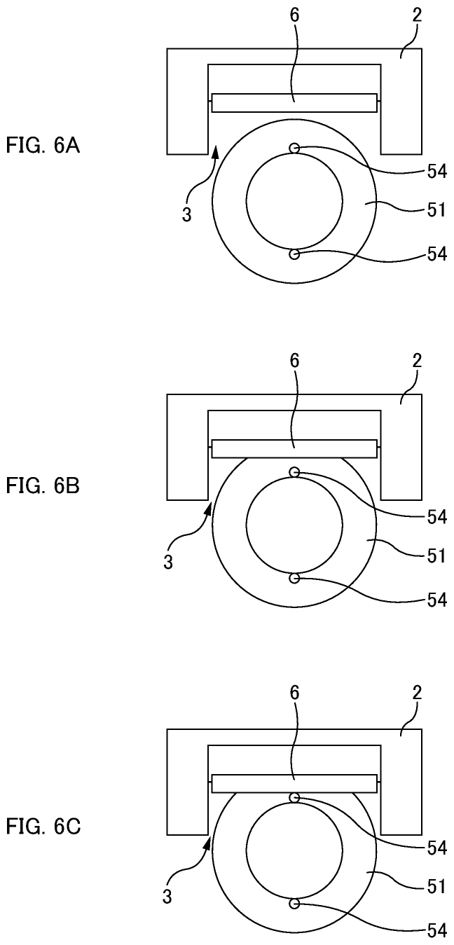

FIGS. 6A to 6C are explanatory diagrams illustrating a method for removing a jacket by the jacket removal tool 1 according to one or more embodiments. First, an operator prepares the jacket removal tool 1 described above, and removes the lid 13. Next, the operator presses the groove part of the jacket removal tool 1 against the optical fiber cable 50 along the longitudinal direction of the optical fiber cable 50, and abuts the blade 6 of the jacket removal tool 1 against the jacket 51 of the optical fiber cable 50. Note that FIGS. 6A to 6C illustrate that the longitudinal direction of the optical fiber cable 50 is a direction connecting the back to the front of the paper plane. At this time, when a protrusion is formed on the jacket 51 as a place where the rip cord 54 is buried, the operator abuts the blade 6 with the protrusion as a mark.

Next, the operator moves the jacket removal tool 1 toward the rear along the longitudinal direction of the optical fiber cable. As illustrated in FIG. 5, the cutting edge 6A of the blade 6 faces the rear, and thus the jacket 51 can be shaved so as to be shaved with a plane by moving the jacket removal tool 1 toward the rear. In this way, moving the jacket removal tool 1 toward the rear along the longitudinal direction of the optical fiber cable may be referred to as a “shaving operation” below.

As described above, the shaving thickness Y by one shaving operation is smaller than the buried depth Y of the rip cord, and thus the rip cord is not exposed by the first shaving operation. Note that FIG. 6B illustrates a diagram during the first shaving operation. Subsequently performing the shaving operation for a plurality of times reaches the buried depth X of the rip cord 54. Then, the operator terminates the shaving operation in a stage where the rip cord 54 is exposed (refer to FIG. 6C). In other words, timing at which the shaving operation is terminated is timing at which the rip cord 54 is exposed. In this way, the shaving operation can be performed without exceeding the buried depth X of the rip cord 54, and damage to the wrapping tape 52 (furthermore, the optical fibers 50A in the wrapping tape 52) can be suppressed.

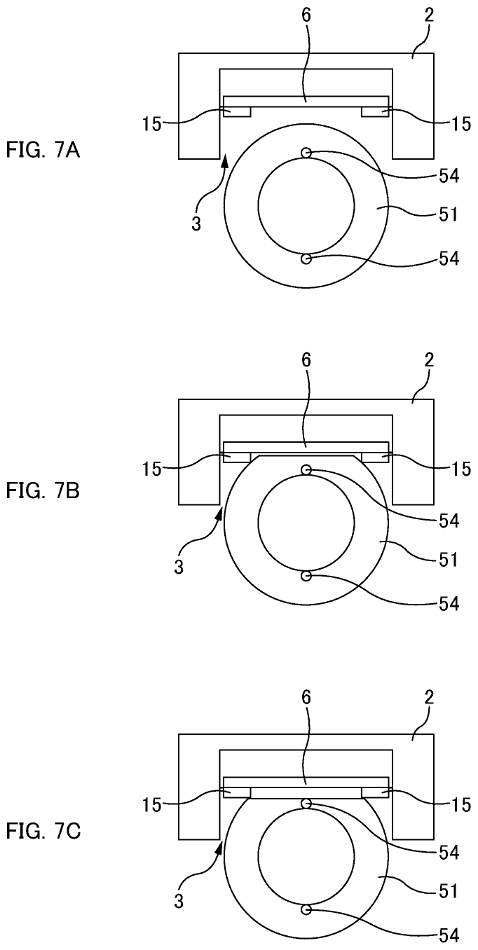

FIGS. 7A to 7C are explanatory diagrams illustrating a method for removing a jacket by a jacket removal tool 1 according to one or more embodiments. In the jacket removal tool 1 according to the embodiments described above, the shaving operation is terminated in the stage where the rip cord 54 is exposed. However, in the jacket removal tool 1 according to one or more embodiments described below, a blade 6 may be provided with a shaving stopper 15. As illustrated in FIGS. 7A to 7C, the shaving stopper 15 is provided on left and right ends of the blade 6. As illustrated in FIG. 7C, the size of the shaving stopper 15 is adjusted such that the blade 6 does not reach a jacket 51 in a stage where a rip cord 54 is exposed. In this way, an operator can terminate the shaving operation at timing at which the blade 6 does not reach the jacket 51 without checking whether or not the rip cord 54 is exposed.

### Modified Example

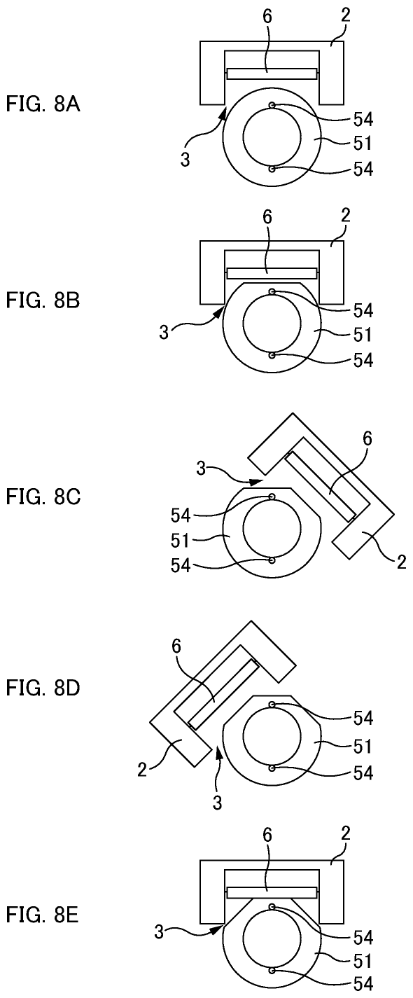

FIGS. 8A to 8E are explanatory diagrams illustrating a method for removing a jacket according to a modified example. An optical fiber cable being a jacket removal target in the present modified example has an outer diameter greater than an outer diameter of the optical fiber cable described in the embodiments described above. Therefore, as the shaving operation proceeds, a corner(s) of the groove part 3 of the jacket removal tool 1 abuts the optical fiber cable, and the blade 6 does not reach the jacket 51. Then, the shaving operation may not be able to proceed further (refer to FIG. 8B). However, even in such a case, the shaving operation is performed by shifting the optical fiber cable in a circumferential direction, and a part in which the corner of the groove part 3 abuts the optical fiber cable is shaved, and thus the subsequent shaving operation can proceed (refer to FIGS. 8C to 8E).

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1: Jacket removal tool;
2: Body part;
2A: Upper body part;
2B: Lower body part;
3: Groove part;
3A: Groove part bottom surface;
4: Fixing screw;
5: Blade part;
6: Blade;
6A: Cutting edge;
6B: Polishing surface;
7: Fixing screw;
8: Blade counterpart;
9: Blade rest;
10: Counter side surface;
11: Counter bottom surface;
12: Edge part;
13: Lid;
14: Opening;
15: Shaving stopper;
50: Optical fiber cable;
50A: Optical fiber;
51: Jacket;
52: Wrapping tape;
53: Tensile strength member;
54: Rip cord;
55: Optical fiber unit.

1. A jacket removal tool for an optical cable in which a rip cord is buried in a jacket, the jacket removal tool comprising:
a blade that shaves the jacket; and
a blade counterpart, wherein
an opening through which a part of the jacket shaved by the blade passes is disposed between the blade and the blade counterpart, and
the blade counterpart comprises:
a counter bottom surface along the optical cable;
a counter side surface connected to the counter bottom surface; and
an edge that connects the counter bottom surface and the counter side surface and that is disposed along a perpendicular line extending from a cutting edge of the blade with respect to the counter bottom surface, wherein
the edge is parallel to a blade line of the cutting edge.

2. The jacket removal tool according to claim 1, wherein a distance between the edge and the cutting edge is smaller than a buried depth of the rip cord.

3. The jacket removal tool according to claim 1, further comprising:
a body that holds the blade counterpart and that comprises a groove that guides the optical cable.

4. The jacket removal tool according to claim 3, wherein a bottom surface of the groove is curved and protrudes toward the optical cable.

5. The jacket removal tool according to claim 1, further comprising:
a shaving stopper that prevents the blade from shaving the jacket to a depth deeper than the rip cord.

6. A method for removing a jacket of an optical cable that includes a rip cord buried in the jacket with a jacket removal tool that includes a blade that shaves the jacket and a blade counterpart that together with the blade forms an opening through which a part of the jacket shaved by the blade passes, wherein the blade counterpart includes a counter bottom surface along the optical cable that is connected to a counter side surface by an edge that is disposed along a perpendicular line extending from a cutting edge of the blade with respect to the counter bottom surface and that is parallel to a blade line of the cutting edge, the method comprising:
preparing the jacket removal tool for the optical cable; and
while pressing the blade against the jacket, moving the jacket removal tool along a longitudinal direction of the optical cable to remove the jacket.

7. The method according to claim 6, further comprising:
repeating the moving of the jacket removal tool until the rip cord is exposed.
